(19) United States
(12) Patent Application Publication
(10) Pub. No.: US 2025/0171338 A1
(43) Pub. Date: May 29, 2025

(54) AERATION GRID WITHIN A WASTEWATER TREATMENT UNIT

(71) Applicant: Advanced Drainage Systems, Inc., Hilliard, OH (US)

(72) Inventors: Adam MILLER, Haddam, CT (US); Bryan COPPES, Old Saybrook, CT (US); Daniel J. SWISTAK, Newmarket, NH (US); Mark YOUNGCLAUS, Waterford, CT (US)

(73) Assignee: Advanced Drainage Systems, Inc., Hilliard, OH (US)

(21) Appl. No.: 18/963,060

(22) Filed: Nov. 27, 2024

Related U.S. Application Data
(60) Provisional application No. 63/603,351, filed on Nov. 28, 2023.

(51) Int. Cl. C02F 3/20; B01F 23/231; B01F 23/237; B01F 101/00

(52) U.S. Cl. CPC C02F 3/201; B01F 23/231231; B01F 23/231265; B01F 23/237612; B01F 2101/305; B01F 2215/0427; B01F 2215/0431

(57) ABSTRACT

An aeration grid is provided. The aeration grid may comprise a curved body, a plurality of aeration extensions extending from the curved body, wherein each of the plurality of aeration extensions may comprise one or more aeration openings, and a plurality of nesting extrusions extending between the curved body and the plurality of aeration extensions.

### CROSS-REFERENCE TO RELATED APPLICATIONS

This application claims benefit of priority of U.S. Provisional Patent Application No. 63/603,351, filed on Nov. 28, 2023. The contents of the foregoing application are incorporated herein by reference in its entirety.

### TECHNICAL FIELD

This disclosure relates generally to systems, methods, and apparatuses for treating wastewater through a wastewater treatment system, and, more particularly, to treating wastewater through use of an aeration grid within a wastewater treatment system.

### BACKGROUND

Wastewater from a residential or commercial building may often be treated by an onsite subsurface wastewater treatment system. The onsite subsurface wastewater treatment system may comprise a primary tank that receives the flow of wastewater from a source in the residential or commercial building. Residuals may settle out of the flow of wastewater and remain in the primary tank while the wastewater flows from the primary tank to a septic tank. A wastewater treatment unit with an aeration grid may be provided in the septic tank. The wastewater treatment unit may facilitate nitrification of the wastewater through the use of the aeration grid. Denitrification may also occur in the anoxic area of the septic tank to further treat the wastewater. The treated wastewater may then flow through a discharge assembly to a dispersal system.

Existing wastewater treatment systems may utilize an aeration process to reduce nitrogen, bacterial nutrients, biochemical oxygen demand (BOD), and total suspended solids (TSS) from the wastewater flowing through the system. Such existing wastewater treatment systems may include an aeration system designed to release oxygen directly into the wastewater to promote aerobic biodegradation. Adding oxygen into the wastewater may increase aerobic activity and encourage microbial growth in the wastewater. The microbes may then biologically degrade suspended solids in the wastewater. The suspended solids may then settle out of the wastewater into a sludge at the bottom of the septic tank.

However, solutions are needed to improve the reduction of BOD, TSS, nitrogen, and bacterial nutrients from wastewater through wastewater treatment systems. Such solutions should provide a wastewater treatment unit with an aeration grid that provides oxygen into the wastewater treatment unit to increase the level of bacteria that accelerate the process of breaking down suspended solids in wastewater. Such an aeration grid should be balanced with a designed backpressure such that the aeration grid may still function when in an out-of-level configuration, through, for example, erroneous assembly or as a wastewater treatment unit settles in the ground over time, without losing air flow to the designed locations within the aeration grid. Such solutions should also comprise a wastewater treatment unit and aeration grid that are time and cost efficient to transport, install, and maintain. For example, such solutions should provide an aeration grid without vertical components that may be stored and shipped efficiently and that do not include mechanical parts internal to the system for ease of maintenance. Additionally, solutions should comprise a wastewater treatment unit with an aeration grid that may be installed in any standard-size septic tank.

### SUMMARY

Consistent with disclosed embodiments, systems, apparatuses, and methods for treating wastewater through a wastewater treatment system including an aeration grid are disclosed. The disclosed embodiments may include an aeration grid unit that may comprise a curved body, a plurality of aeration extensions extending from the curved body, wherein each of the plurality of aeration extensions may comprise one or more aeration openings, and a plurality of nesting extrusions extending between the curved body and the plurality of aeration extensions. In some embodiments, the curved body may comprise a single molded pipe. In some embodiments, the curved body may comprise a series of interconnected pipes. In some embodiments, an end of the curved body may comprise an opening configured to be connected to an air distribution supply pipe. In some embodiments, a first end of the curved body and a second end of the curved body may be configured to be installed through a first opening and a second opening in a wastewater water treatment unit. In some embodiments, the plurality of aeration extensions may comprise parallel pipes extending from the curved body. In some embodiments, the plurality of nesting extrusions may be configured to facilitate stacking of a plurality of aeration grid units. In some embodiments, the one or more aeration openings may comprise an opening in the plurality of aeration extensions. In some embodiments, the one or more aeration openings may be configured to release oxygen from within the plurality of aeration extensions into a wastewater treatment unit. In some embodiments, the one or more aeration openings may be located at least 1.5 inches from an end of each of the plurality of aeration extensions.

In some embodiments, the aeration grid unit may further comprise a plurality of nesting supports. In some embodiments, the plurality of nesting supports may comprise horizontal extensions from the curved body. In some embodiments, the plurality of nesting supports may be configured to facilitate stacking of a plurality of aeration grid units. In some embodiments, a length of the curved body may be approximately 54 inches. In some embodiments, a length of the plurality of aeration grid extensions may be approximately 20 inches. In some embodiments, a distance between two of the plurality of aeration grid extensions may be approximately 18 inches. In some embodiments, a diameter of each of the one or more aeration openings may be approximately 0.3 inches. In some embodiments, the plurality of aeration grid extensions may comprise six aeration grid extensions. In some embodiments, two aeration grid extensions of the plurality of aeration grid extensions may be aligned across the curved body. In some embodiments, the plurality of aeration grid extensions may extend from a first side and a second side of the curved body.

Additional features and advantages of the disclosed embodiments will be set forth in part in the description that follows, and in part will be obvious from the description, or may be learned by practice of the disclosed embodiments.

It is to be understood that both the foregoing general description and the following detailed description are examples and explanatory only and are not restrictive of the disclosed embodiments.

The accompanying drawings constitute a part of this specification. The drawings illustrate several embodiments of the present disclosure and, together with the description, serve to explain the principles of the disclosed embodiments.

### BRIEF DESCRIPTION OF THE DRAWINGS

FIG. 1A depicts a perspective view of an aeration grid unit, consistent with embodiments of the present disclosure.

FIG. 1B depicts a bottom view of an aeration grid unit, consistent with embodiments of the present disclosure.

FIG. 2 depicts a perspective view of a plurality of interconnected aeration grid units, consistent with embodiments of the present disclosure.

FIG. 3 depicts a perspective view of an aeration grid unit installed within a wastewater treatment unit, consistent with embodiments of the present disclosure.

FIG. 4 depicts a top view of an aeration grid unit installed within a wastewater treatment unit, consistent with embodiments of the present disclosure.

FIG. 5 depicts a top view of an aeration grid unit with an example of dimensions, consistent with embodiments of the present disclosure.

FIG. 6 depicts a section cut of the aeration grid unit of FIG. 5 at cut line C-C, consistent with embodiments of the present disclosure.

FIG. 7 depicts a section cut of the aeration grid unit of FIG. 5 at cut line B-B, consistent with embodiments of the present disclosure.

FIG. 8 depicts a section cut of the aeration grid unit of FIG. 5 at cut line A-A, consistent with embodiments of the present disclosure.

FIG. 9 depicts a side view of an aeration grid unit with an example of dimensions, consistent with embodiments of the present disclosure.

FIG. 10 depicts a front view of an aeration grid unit with an example of dimensions, consistent with embodiments of the present disclosure.

### DETAILED DESCRIPTION

Example embodiments are described with reference to the accompanying drawings.

The disclosed embodiments improve deficiencies in existing aeration grid systems by providing a system that reduces BOD, TSS, nitrogen, and bacterial nutrients from wastewater through the use of an aeration grid within a wastewater treatment unit. The disclosed embodiments further improve deficiencies in existing aeration grid systems by providing a system that is easy to install, requires minimal maintenance, and may be installed in any standard-sized septic tank. The disclosed embodiments also improve deficiencies in existing aeration grid systems by providing a system without vertical leg drops that may be installed out of level without losing air flow to the designed outlet locations.

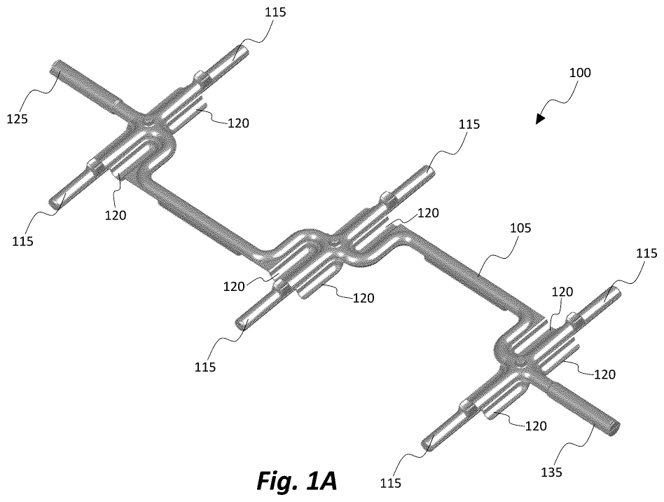

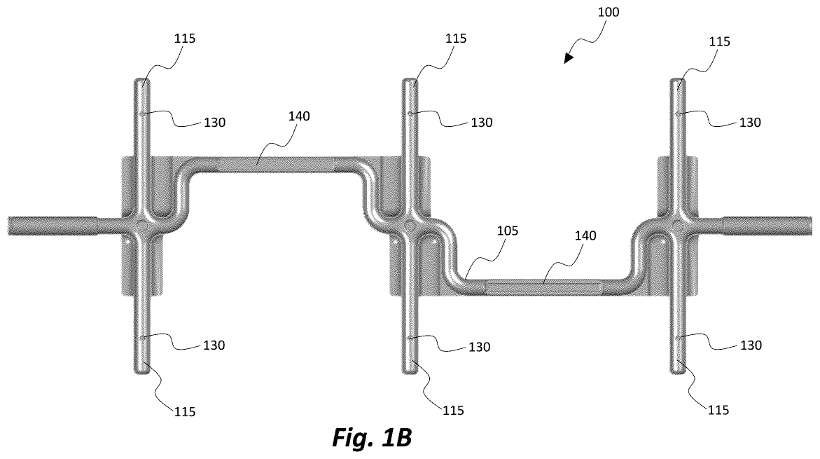

FIG. 1A depicts a perspective view of an aeration grid unit 100, consistent with embodiments of the present disclosure. In an embodiment, the aeration grid unit 100 may be made from a thermoplastic polymer such as acrylonitrile butadiene styrene (ABS), polyvinyl chloride (PVC), or any suitable polymers for forming an aeration grid unit 100. Aeration grid unit 100 may be balanced with a designed backpressure that forms a meniscus within aeration grid unit 100, such that vertical leg drops are not required to provide balance to aeration grid unit 100. The backpressure within aeration grid unit 100 may be formed by balancing blower pressure, air flow volume, and the size and location of openings on aeration grid unit 100. Aeration grid unit 100 may be installed out of level, either as a result of user error or settling of the wastewater treatment unit, however the designed backpressure allows oxygen to be released from all designated openings in the aeration grid unit 100 despite aeration grid unit 100 being out of level, as will be discussed further below with reference to FIG. 1B.

The aeration grid unit 100 may comprise a curved body 105. The curved body 105 may comprise a single molded pipe or a series of interconnected pipes designed to carry oxygen into the wastewater treatment unit. As depicted in FIG. 1A, curved body 105 may comprise a single molded pipe which may allow for more flexibility in the size, shape, and curvature of curved body 105 than if curved body 105 is formed through a series of interconnected pipes. For example, forming curved body 105 from a single molded pipe may allow curved body 105 to form any air-carrying path without limitations in the shape, size, or curvature of curved body 105 that may be caused by using standard pipes and pipe fittings. Curved body 105 may be formed to fit around other components within the wastewater treatment unit or to carry oxygen to specific sections of the wastewater treatment unit. One end of curved body 105, such as first end 125, may comprise an opening and may be connected, by an air distribution supply pipe, to an above-ground air compressor. The above-ground air compressor may supply oxygen to the curved body 105 of aeration grid unit 100. First end 125 and second end 135 may connect aeration grid unit 100 to a wastewater treatment unit by inserting first end 125 and second end 135 through openings in the walls of the wastewater treatment unit. By installing end 125 and end 135 into the walls of the wastewater treatment unit, the aeration grid unit 100 may be secured within the wastewater treatment unit.

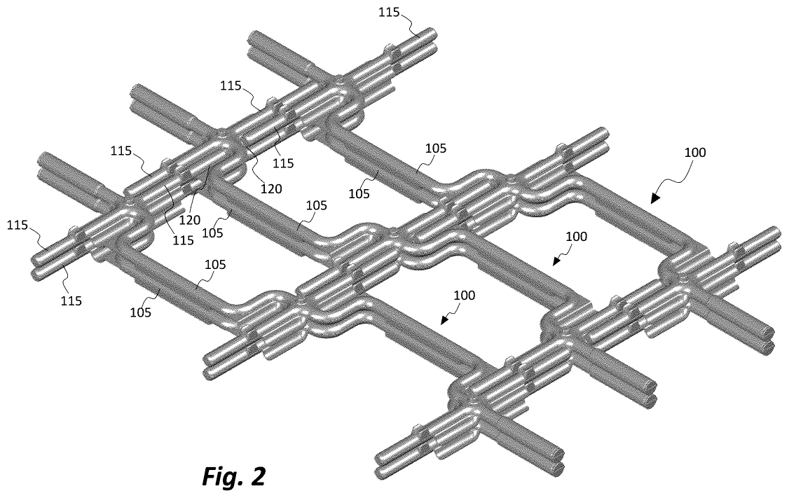

Aeration grid unit 100 may further comprise a plurality of aeration extensions 115 which may extend from curved body 105. The plurality of aeration extensions 115 may comprise parallel pipes that may facilitate the release of oxygen from curved body 105 into the surrounding wastewater. Each aeration grid extension 115 may extend from either side of curved body 105. As depicted in FIG. 1A, two aeration grid extensions 115 may be aligned across curved body 105. Although FIG. 1A depicts a horizontal aeration grid unit 100, vertical piping components may be connected to each of the aeration extensions 115 to provide a vertical leg drop from horizontal aeration grid unit 100. Such vertical piping components may be connected to each aeration extension 115 prior to installing aeration grid unit 100 within a wastewater treatment unit. Aeration grid unit 100 may further comprise a plurality of nesting extrusions 120. Nesting extrusions 120 may comprise curved portions that extend from curved body 105 and aeration extensions 115. Nesting extrusions 120 may facilitate stacking of multiple aeration grid units 100 and may provide structural support to aeration grid unit 100. The size and shape of nesting extrusions 120 may correspond to the size and shape of curved body 105 and aeration extensions 115 such that the aeration extension 115 of one aeration grid unit 100 may be placed within nesting extrusion 120 of a second aeration grid unit 100, as described below and depicted in FIG. 2. Although FIG. 1A depicts six aeration grid extensions 115, aeration grid unit 100 may include any number of aeration grid extensions 115.

FIG. 1B depicts a bottom view of aeration grid unit 100, consistent with embodiments of the present disclosure. As depicted in FIG. 1B, curved body 105 may further comprise nesting supports 140. Nesting supports 140 may comprise horizontal extensions from curved body 105. Nesting supports 140 may facilitate the stacking of multiple aeration grid units 100, such that multiple aeration grid units 100 may be securely and efficiently stacked for storage or transportation. Nesting supports 140 may additionally provide structural support to curved body 105.

As depicted in FIG. 1B, aeration extensions 115 may further comprise aeration openings 130. Aeration openings 130 may comprise openings in the aeration extensions 115 that may allow for the release of oxygen from within the aeration extensions 115 into surrounding wastewater within the wastewater treatment unit. Aeration openings 130 may be located at least 1.5 inches from each end of the aeration extensions 115, which provides a safe clearance for water trapped within aeration extensions 115 that may accumulate when the aeration grid unit 100 is installed out of level. Because of the backpressure within aeration extensions 115, a meniscus may form near aeration openings 130 that allows oxygen to be released through all aeration openings 130 even if the aeration grid unit 100 is out of level. Such designed backpressure allows all aeration openings 130 to remain open and operable despite an accumulation of water within aeration extensions 115. The designed backpressure and meniscus formed within aeration extensions 115 may minimize the amount of external pressure that needs to be provided by the attached air compressor system to allow oxygen to be released from all aeration openings 130. While the embodiment depicted in FIG. 1B depicts one aeration opening 130 on each aeration extension 115, additional or fewer aeration openings 130 may be provided on each aeration extension 115 to allow for the release of oxygen from within aeration extensions 115. While not depicted in the embodiment of FIG. 1B, aeration openings 130 may also be provided throughout curved body 105.

FIG. 2 depicts a perspective view of a plurality of interconnected aeration grid units 100, consistent with embodiments of the present disclosure. As depicted in FIG. 2, each of the aeration grid units 100 may be stacked on top of each other. Because aeration grid unit 100 is balanced with a designed backpressure that forms a meniscus within aeration grid unit 100, vertical leg drops are not required. The lack of vertical leg drops allows aeration grid units 100 to be efficiently stacked for storage and transportation, as depicted in FIG. 2. An aeration extension 115 of one aeration grid unit 100 may be placed within a nesting extrusion 120 of a second aeration grid unit 100. Such nesting of aeration grids 100 may allow for secure and efficient stacking of aeration grid units 100 for storage and transportation.

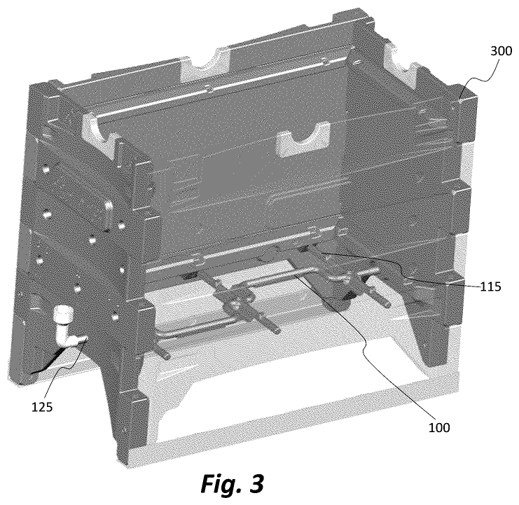

FIG. 3 depicts a perspective view of an aeration grid unit 100 installed within a wastewater treatment unit 300 and FIG. 4 depicts a top view of an aeration grid unit 100 installed within a wastewater treatment unit 300. As depicted in FIG. 3, aeration grid unit 100 may be installed within a lower portion of wastewater treatment unit 300, so that oxygen released from aeration extensions 115 of curved body 105 may be mixed within the wastewater flowing through the wastewater treatment unit 300. As depicted in FIGS. 3 and 4, first end 125 and second end 135 may be installed through the inner walls of the wastewater treatment unit 300 to secure the aeration grid unit 100 within the wastewater treatment unit 300. First end 125 may extend through a wall of wastewater treatment unit 300 to be connected, by an air distribution supply pipe, to an above-ground air compressor, or another source of air as would be known by a person of ordinary skill in the art. Although FIG. 3 and FIG. 4 depict one aeration grid unit 100 installed within a wastewater treatment unit 300, a plurality of aeration grid units 100 may be interconnected in series to form a longer aeration grid for installation in a larger wastewater treatment unit. Alternatively, a plurality of aeration grid units 100 may be installed in parallel to provide a wider aeration grid for installation in a larger wastewater treatment unit.

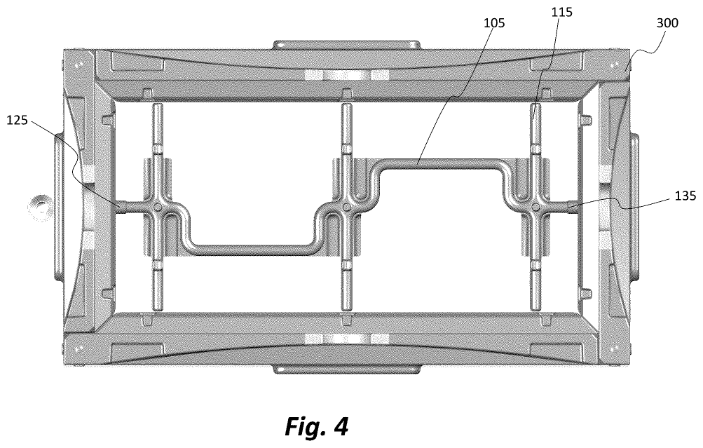

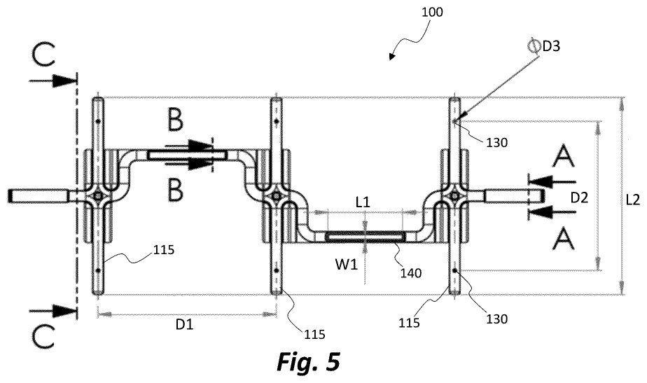

FIG. 5 depicts a bottom view of aeration grid unit 100. As depicted in FIG. 5, aeration extensions 115 may be spaced apart a distance D1. In some embodiments, distance D1 may be approximately 18 inches. In other embodiments, distance D1 may be greater than or less than 18 inches. Nesting supports 140 of aeration grid unit 100 may include a length L1 and a width W1. In some embodiments, length L1 may be approximately 7.5 inches. In other embodiments, length L1 may be greater than or less than 7.5 inches. In some embodiments, width W1 may be approximately 0.5 inches. In other embodiments, width W1 may be greater than or less than 0.5 inches. In some embodiments, aeration extensions 115 may include a length L2. In some embodiments, length L2 may be approximately 20 inches. In other embodiments, length L2 may be greater than or less than 20 inches. Aeration openings 130 of aeration extensions 115 may be spaced apart a distance D2. In some embodiments, distance D2 may be approximately 15 inches. In other embodiments, distance D2 may be greater than or less than 15 inches. Aeration openings 130 may further include a diameter D3. Diameter D3 of aeration openings 130 may be approximately 0.3 inches. In other embodiments, diameter D3 may be greater than or less than 0.3 inches.

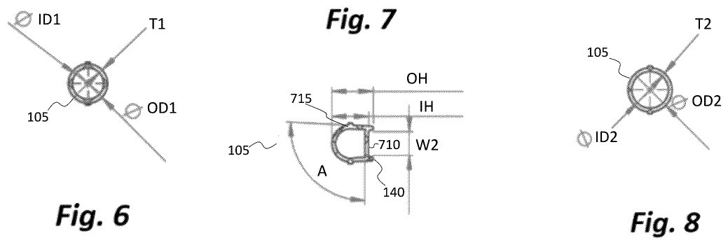

FIG. 6 depicts a section view of curved body 105 at section line C-C, as depicted in FIG. 5. As depicted in FIG. 6, curved body 105 may include an inner diameter ID1 and an outer diameter OD1. Inner diameter ID1 may include a distance from an internal wall of curved body 105 through a center point of curved body 105 to an internal wall on an opposite side of curved body 105. Outer diameter OD1 may include a distance from an external wall of curved body 105 through a center point of curved body 105 to an external wall on an opposite side of curved body 105. In some embodiments, inner diameter ID1 may be approximately 0.8 inches. In other embodiments, inner diameter ID1 may be greater than or less than 0.8 inches. In some embodiments, outer diameter OD1 may be approximately 1 inch. In other embodiments, outer diameter OD1 may be greater than or less than 1 inch. Curved body 105 at section line C-C may further include wall thickness T1. In some embodiments, wall thickness T1 may be approximately 0.1 inches. In other embodiments, wall thickness T1 may be greater than or less than 0.1 inches.

FIG. 7 depicts a section view of curved body 105 and nesting support 140 at section line B-B, as depicted in FIG. 5. As depicted in FIG. 7, nesting support 140 may include a width W2. In some embodiments, width W2 may be approximately 0.7 inches. In other embodiments, width W2 may be greater than or less than 0.7 inches. Curved body 105 may include an inner height IH and an outer height OH. In some embodiments, inner height IH may be approximately 1 inch. In other embodiments, inner height IH may be greater than or less than 1 inch. In some embodiments, outer height OH may be approximately 1.15 inches. In other embodiments, outer height may be greater than or less than 1.15 inches. In some embodiments, wall 715 of curved body 105 may be offset at an angle from base 710 of curved body. For example, an angle A between base 710 and wall 715 of curved body may be approximately 93 degrees. In other embodiments, angle A may be greater than or less than 93 degrees.

FIG. 8 depicts a section cut of curved body 105 at section line A-A, as depicted in FIG. 5. As depicted in FIG. 8, curved body 105 may include an inner diameter ID2 and an outer diameter OD2. Inner diameter ID2 may include a distance from an internal wall of curved body 105 through a center point of curved body 105 to an internal wall on an opposite side of curved body 105. Outer diameter OD2 may include a distance from an external wall of curved body 105 through a center point of curved body 105 to an external wall on an opposite side of curved body 105. In some embodiments, inner diameter ID2 may be approximately 1 inch. In other embodiments, inner diameter ID2 may be greater than or less than 1 inch. In some embodiments, outer diameter OD2 may be approximately 1.2 inches. In other embodiments, outer diameter OD2 may be greater than or less than 1.2 inches. Curved body 105 at section line C-C may further include wall thickness T2. In some embodiments, wall thickness T2 may be approximately 0.1 inches. In other embodiments, wall thickness T2 may be greater than or less than 0.1 inches.

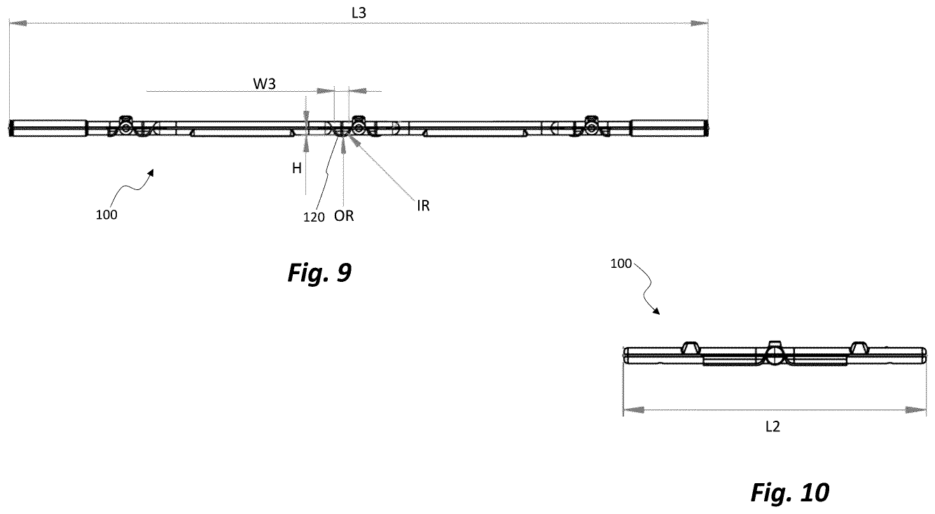

FIG. 9 depicts a side view of aeration grid unit 100. In some embodiments, a length L3 of aeration grid unit 100 may be approximately 54 inches. In other embodiments, length L3 of aeration grid unit 100 may be greater than or less than 54 inches. Nesting extrusion 120 may include width W3 and height H. In some embodiments, width W3 may be approximately 1.2 inches. In other embodiments, width W3 may be greater than or less than 1.2 inches. In some embodiments, height H may be approximately 0.5 inches. In other embodiments, height H may be greater than or less than 0.5 inches. Nesting extrusions 120 may further include inner radius IR and outer radius OR. In some embodiments, inner radius IR may be approximately 0.4 inches. In other embodiments, inner radius IR may be greater than or less than 0.4 inches. In some embodiments, outer radius OR may be approximately 0.5 inches. In other embodiments, outer radius OR may be greater than or less than 0.5 inches.

FIG. 10 depicts a front view of aeration grid unit 100. Aeration grid unit 100 may include length L2. In some embodiments, length L2 may be approximately 20 inches. In other embodiments, length L2 may be greater than or less than 20 inches.

The foregoing description has been presented for purposes of illustration. It is not exhaustive and is not limited to precise forms or embodiments disclosed. Modifications and adaptations of the embodiments will be apparent from consideration of the specification and practice of the disclosed embodiments.

Moreover, while illustrative embodiments have been described herein, the scope includes any and all embodiments having equivalent elements, modifications, omissions, combinations (e.g., of aspects across various embodiments), adaptations and/or alterations based on the present disclosure. Other embodiments will be apparent from consideration of the specification and practice of the embodiments disclosed herein.

What is claimed is:

1. An aeration grid unit, comprising:
a curved body;
a plurality of aeration extensions extending from the curved body, wherein each of the plurality of aeration extensions comprises one or more aeration openings; and
a plurality of nesting extrusions extending between the curved body and the plurality of aeration extensions.

2. The aeration grid unit of claim 1, wherein the curved body comprises a single molded pipe.

3. The aeration grid unit of claim 1, wherein the curved body comprises a series of interconnected pipes.

4. The aeration grid unit of claim 1, wherein an end of the curved body comprises an opening configured to be connected to an air distribution supply pipe.

5. The aeration grid unit of claim 1, wherein a first end of the curved body and a second end of the curved body are configured to be installed through a first opening and a second opening in a wastewater treatment unit.

6. The aeration grid unit of claim 1, wherein the plurality of aeration extensions comprise parallel pipes extending from the curved body.

7. The aeration grid unit of claim 1, wherein the plurality of nesting extrusions are configured to facilitate stacking of a plurality of aeration grid units.

8. The aeration grid unit of claim 1, wherein the one or more aeration openings comprise an opening in the plurality of aeration extensions.

9. The aeration grid unit of claim 8, wherein the one or more aeration openings are configured to release oxygen from within the plurality of aeration extensions into a wastewater treatment unit.

10. The aeration grid unit of claim 1, wherein the one or more aeration openings are located at least 1.5 inches from an end of each of the plurality of aeration extensions.

11. The aeration grid unit of claim 1, further comprising a plurality of nesting supports.

12. The aeration grid unit of claim 11, wherein the plurality of nesting supports comprise horizontal extensions from the curved body.

13. The aeration grid unit of claim 11, wherein the plurality of nesting supports are configured to facilitate stacking of a plurality of aeration grid units.

14. The aeration grid unit of claim 1, wherein a length of the curved body is approximately 54 inches.

15. The aeration grid unit of claim 1, wherein a length of the plurality of aeration grid extensions is approximately 20 inches.

16. The aeration grid unit of claim 1, wherein a distance between two of the plurality of aeration grid extensions is approximately 18 inches.

17. The aeration grid unit of claim 1, wherein a diameter of each of the one or more aeration openings is approximately 0.3 inches.

18. The aeration grid unit of claim 1, wherein the plurality of aeration grid extensions comprise six aeration grid extensions.

19. The aeration grid unit of claim 1, wherein two aeration grid extensions of the plurality of aeration grid extensions are aligned across the curved body.

20. The aeration grid unit of claim 1, wherein the plurality of aeration grid extensions extend from a first side and a second side of the curved body.
